(19) United States
(12) Patent Application Publication
(10) Pub. No.: US 2023/0061153 A1
(43) Pub. Date: Mar. 2, 2023

(54) ACTIVITY MAT FOR KINESTHETIC LEARNERS TO DEVELOP COGNITIVE SKILLS

(71) Applicant: Kamaria Blackett-Munir, Brooklyn, NY (US)

(72) Inventor: Kamaria Blackett-Munir, Brooklyn, NY (US)

(21) Appl. No.: 17/821,224

(22) Filed: Aug. 22, 2022

Related U.S. Application Data
(60) Provisional application No. 63/236,759, filed on Aug. 25, 2021.

(51) Int. Cl. G09B 1/06

(52) U.S. Cl. CPC G09B 1/06

(57) ABSTRACT

An activity mat for kinesthetic learners to develop cognitive skills through several movement patterns, that has a lateral line running in a lateral direction and a longitudinal line running in a longitudinal direction, thereby dividing the activity mat into four square segments. Each one of the respective square segments has an attachment means provided and four detachable indicia provided on the plurality of respective segments through the four respective attachments means.

### TECHNICAL FIELD

The present invention generally relates to educational devices for children. More specifically the present invention relates to educational devices designed for kinesthetic and tactile learners.

### BACKGROUND ART

Kinesthetic learning, sometimes also referred to as tactile learning is a form of learning that involves partial or total body movements in the learning process. Kinesthetic learning is suited for students who learn best with projects, role play, game-like activities, or an option to move around in a hands-on environment, enabling deep learning via the process of doing. Conventional solutions to enable kinesthetic learning include poly-spots, carpet markers, classroom rugs, decal markings, and floor tapes. However, such solutions take up lots of space and can only be incorporated in large educational facilities due to their sheer size and extensive costs.

Therefore, there is a need for a device that overcomes the disadvantages and limitations associated with the prior art and provides a more satisfactory solution.

### OBJECTS OF THE INVENTION

Some of the objects of the invention are as follows:

An object of the invention is to provide a device that enables kinesthetic and tactile learning;

Another object of the invention is to provide a device for kinesthetic and tactile learning that is foldable and does not take an extensive amount of space; and

Yet another object of the invention is to provide a device for kinesthetic and tactile learning that is economical to afford and relatively convenient to use.

### SUMMARY OF THE INVENTION

According to a first aspect of the present invention, there is provided an activity mat for the development of cognitive skills through several movement patterns, the activity mat comprises a lateral line running in a lateral direction and a longitudinal line running in a longitudinal direction, thereby dividing the activity mat into four square segments, four attachment means provided on each one of the respective four segments, and four detachable indicia provided on the respective four segments through the four respective attachments means.

In one embodiment of the invention, movement patterns include, but are not limited to, stepping, hopping, jumping, kneeling, planking, and bouncing a ball.

In one embodiment of the invention, the activity mat is square in shape and the four segments as a result are also square in shape.

In one embodiment of the invention, the four attachment means are selected from a group consisting of loop and hook fasteners, adhesive attachments, and attachments through thumbnails.

In one embodiment of the invention, the four indicia represent answer responses to a question asked of a user.

In one embodiment of the invention, the activity mat is configured to fold across the lateral line and the longitudinal line.

In one embodiment of the invention, the activity mat further includes a carrying folder adapted to carry the activity mat in the folded state.

In one embodiment of the invention, the material of the activity mat is selected from a group consisting of fabric materials, polymeric materials, and composite materials.

### BRIEF DESCRIPTION OF THE ACCOMPANYING DRAWINGS

The accompanying drawings illustrate the best mode for carrying out the invention as presently contemplated and set forth hereinafter. The present invention may be more clearly understood from a consideration of the following detailed description of the preferred embodiments taken in conjunction with the accompanying drawings wherein like reference numerals indicate the corresponding parts in various figures in the accompanying drawings, and in which:

FIG. 1 illustrates a child practicing kinesthetic learning on an activity mat, in accordance with an embodiment of the present invention;

FIG. 2 illustrates a partially exploded view of the activity mat, in accordance with another embodiment of the present invention;

FIG. 3 illustrates a carrying folder for the activity mat in an open state in accordance with an embodiment of the present invention; and

FIG. 4 illustrates the activity mat being carried in a carrying folder, in accordance with an embodiment of the present invention.

### DETAILED DESCRIPTION

Embodiments of the present invention disclosure will be described more fully hereinafter with reference to the accompanying drawings in which like numerals represent like elements throughout the figures, and in which example embodiments are shown.

The detailed description and the accompanying drawings illustrate the specific exemplary embodiments by which the disclosure may be practiced. These embodiments are described in detail to enable those skilled in the art to practice the invention illustrated in the disclosure. It is to be understood that other embodiments may be utilized, and other changes may be made, without departing from the spirit or scope of the present disclosure. The following detailed description is therefore not to be taken in a limiting sense, and the scope of the present invention disclosure is defined by the appended claims. Embodiments of the claims may, however, be embodied in many different forms and should not be construed as limited to the embodiments set forth herein.

It is envisaged that an activity mat in form of a foldable mat is provided to enable kinesthetic learning. The activity mat is envisaged to be divided into several segments through lines running in longitudinal and lateral directions. Each segment may be provided with detachable attachment means, such as loop and hook fasteners, that allow several different kinds of indicia to be removably attached to the several segments. In that regard during learning, a child may move, hop, shift or jump between segments in response to the questions posed to them. After use, the activity mat may be folded along the longitudinal and/or lateral lines and stored in a smaller compartment. Referring to the drawings, the invention will now be explained in further detail.

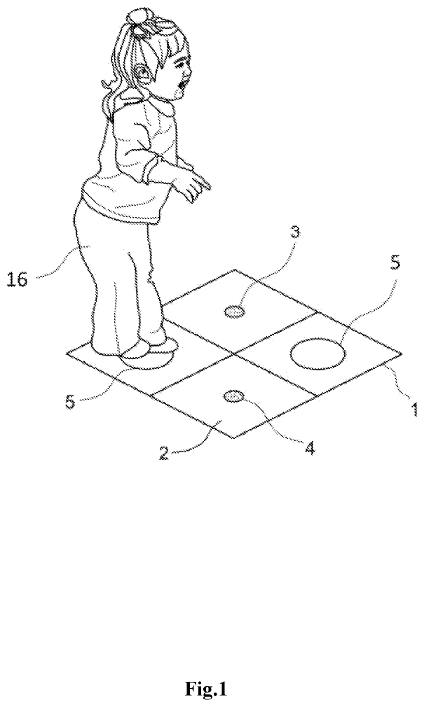

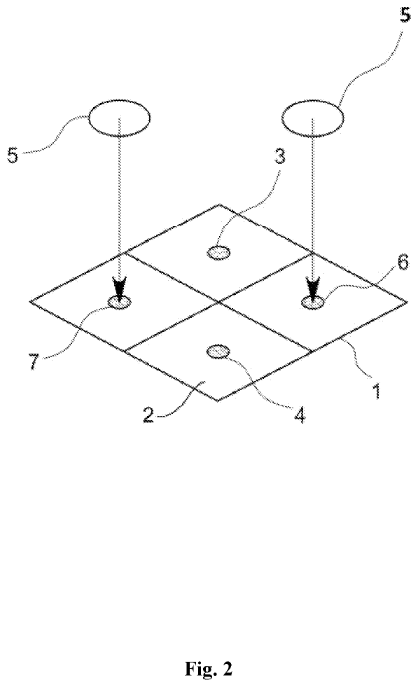

FIG. 1 illustrates a child 16 practicing kinesthetic learning on an activity mat 1, in accordance with an embodiment of the present invention. The activity mat 1 has been divided into four segments 2. FIG. 2 illustrates a partially exploded view of the activity mat 1, in accordance with another embodiment of the present invention. In several embodiments of the invention, the activity mat 1 is square in shape and the four segments 2 as a result are also square in shape.

Further, four attachment means 3, 4, 6, 7 have been provided on each one of the respective four segments 2. The activity mat 1 further includes four detachable indicia 5 provided on the plurality of respective segments through the four respective attachments means 3, 4, 6, 7. In several embodiments of the invention, the four attachment means 3, 4, 6, 7 are selected from a group consisting of loop and hook fasteners, adhesive attachments, and attachments through thumbnails. Child 16 may be learning kinesthetically through several movement patterns such as, but not limited to, stepping, hopping, shifting, or jumping between segments in response to the questions posed to them.

In several alternate embodiments, the plurality of detachable indicia 5 may represent the answer response to several different kinds of questions, in the form of, but not limited to “true” or “false,” “greater than,” “less than,” “equal to,” “yes,” “no”, without departing from the scope of the invention. The material of the activity mat 1 is selected from a group consisting of fabric materials, polymeric materials, and composite materials. The activity mat 1 is configured to fold across the lateral line and the longitudinal line.

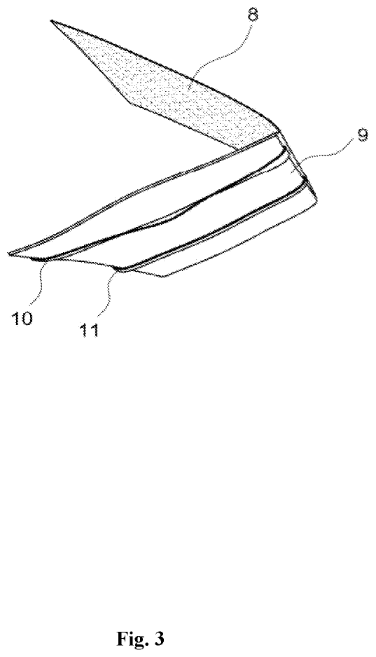

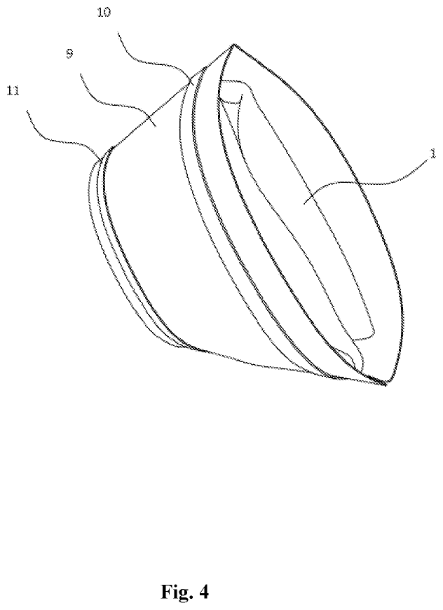

FIG. 3 illustrates a carrying folder 9 for the activity mat 1 in an open state in accordance with an embodiment of the present invention. The carrying folder 9 has a segment 8. The segment 8 has been provided with the attachment means such as an adhesive layer or loop and hook fasteners. When not in use for learning, the detachable indicia 5 can be stored by attaching the detachable indicia 5 on the segment 8. The carrying folder 9 is closed using two elastic loops 10 and 11. When the folder is closed, the two elastic loops 10 and 11 will be pulled over/around the back of the folder (backside of the segment 8) to keep the folder closed. FIG. 4 illustrates the activity mat 1 being carried in the carrying folder 9, in accordance with an embodiment of the present invention. The carrying folder 9 has an upper elastic band 10, and a lower elastic band 11. This activity mat 1 addresses the issues that arise in classrooms and homes with limited space such as those in overcrowded urban settings and smaller residences.

Various modifications to these embodiments are apparent to those skilled in the art, from the description and the accompanying drawings. The principles associated with the various embodiments described herein may be applied to other embodiments. Therefore, the description is not intended to be limited to the embodiments shown along with the accompanying drawings but is to be providing the broadest scope consistent with the principles and the novel and inventive features disclosed or suggested herein. Accordingly, the invention is anticipated to hold on to all other such alternatives, modifications, and variations that fall within the scope of the present invention and appended claims.

1. An activity mat for the development of cognitive skills through several movement patterns, the activity mat comprising:
a lateral line running in a lateral direction and a longitudinal line running in a longitudinal direction, thereby dividing the activity mat into four square segments;
four attachment means provided on each one of the respective four square segments; and
four detachable indicia provided on the plurality of respective segments through the four respective attachments means.

2. The activity mat as claimed in claim 1, wherein movement patterns include stepping, hopping, jumping, kneeling, planking, and bouncing a ball.

3. The activity mat as claimed in claim 1, wherein the activity mat is square in shape and the four segments, as a result, are also square in shape.

4. The activity mat as claimed in claim 1, wherein the four attachment means are selected from a group consisting of loop and hook fasteners, adhesive attachments, and attachments through thumbnails.

5. The activity mat as claimed in claim 1, wherein the activity mat is configured to fold across the lateral line and the longitudinal line.

6. The activity mat as claimed in claim 1, further including a carrying folder adapted to carry the activity mat in the folded state.

7. The activity mat as claimed in claim 1, wherein material of the activity mat is selected from a group consisting of fabric materials, polymeric materials, and composite materials.
